(19) United States
(12) Patent Application Publication
(10) Pub. No.: US 2026/0206803 A1
(43) Pub. Date: Jul. 23, 2026

(54) RETORT-POUCH SHAPED FOOD AND METHOD OF PRODUCING RETORT-POUCH SHAPED FOOD

(71) Applicant: UHA Mikakuto Co., Ltd., Yamatokooriyama-shi, Nara (JP)

(72) Inventors: Shinsuke KITANAKA, Yamatokooriyama-shi (JP); Ai FUJI, Yamatokooriyama-shi (JP); Kiyoshi SUZUKI, Yamatokooriyama-shi (JP); Yasumasa YAMADA, Yamatokooriyama-shi (JP)

(73) Assignee: UHA Mikakuto Co., Ltd., Yamatokooriyama-shi, Nara (JP)

(21) Appl. No.: 19/142,465

(22) PCT Filed: Jan. 29, 2024
(86) PCT No.: PCT/JP2024/002660

§ 371 Date: Jun. 23, 2025

(30) Foreign Application Priority Data
Jan. 31, 2023 (JP) 2023-012691

(51) Int. Cl. A23L 7/196; A23B 9/02; A23L 29/238; A23L 29/244; A23L 29/256

(52) U.S. Cl. CPC A23L 7/196; A23B 9/02; A23L 29/238; A23L 29/244; A23L 29/256

(57) ABSTRACT

Provided is a retort-pouch shaped food that includes glutinous brown rice and a gelling agent. The gelling agent may be one or more ingredients selected from glucomannan, agar, and psyllium. The retort-pouch shaped food may be produced by a producing method that includes: a first step of preparing a viscous liquid containing the glutinous brown rice and the gelling agent; a second step of filling a pouch with the viscous liquid; and a third step of performing retort heat sterilization to the pouch and cooling the pouch, to solidify a content of the pouch into a single lump.

### TECHNICAL FIELD

The present invention relates to a retort-pouch shaped food containing glutinous brown rice as a main ingredient, and to a method of producing the retort-pouch shaped food. More specifically, the present invention relates to a retort-pouch shaped food that contains glutinous brown rice as a main ingredient, and is shaped in a single lump to be eatable as it is at a normal temperature.

### BACKGROUND ART

Brown rice is highly nutritious, and thus is well known and in demand among health-conscious consumers. However, it has not widely penetrated households due to the difficulty in eating caused by its hard outer husk and the time-consuming process of cooking. In order to simplify the cooking, several types of brown-rice congee and cooked brown rice which are packed in retort pouches and can be eaten simply by heating in hot water or in a microwave oven, are proposed (Patent Literatures (PTLs) 1 and 2). However, until now, such brown-rice retort pouch foods available were those that needed to be heated or that could be eaten in a bowl with a spoon, etc., and no brown-rice retort pouch foods that could be eaten anywhere, anytime without using tableware were known.

### CITATION LIST

### Patent Literature

[PTL 1] Japanese Patent No. 4098576
[PTL 2] Japanese Patent No. 5952696

### SUMMARY OF THE INVENTION

### Problems to be Solved by the Invention

A purpose of the present invention is to provide a retort-pouch shaped food having excellent preservation properties, in which highly-nutritious glutinous brown rice is shaped so as to be eaten immediately as it is, like an onigiri (rice ball) or ohagi (rice cake), and to provide a method of producing the retort-pouch shaped food.

### Solution to the Problems

As a result of diligent study by inventors of the present invention to achieve the above purpose, the inventors found that glutinous brown rice could be shaped into a single lump to be taken out of a retort pouch and eaten as it was by dispersing the glutinous brown rice in a viscous liquid containing a gelling agent, and performing retort heat sterilization to the viscous liquid in a pouch. In addition, the inventors found that the shaped food had a desirable texture similar to those of onigiri and ohagi, and completed the invention.

The present invention has the following gist, that is, the present invention is directed to:
(1) A retort-pouch shaped food including: glutinous brown rice; and a gelling agent.
(2) The retort-pouch shaped food according to the above (1), in which a content of a pouch is bound into a single lump as it is at a normal temperature.
(3) The retort-pouch shaped food according to the above (1) or (2), in which the gelling agent is one or more ingredients selected from glucomannan, agar, and psyllium.
(4) The retort-pouch shaped food according to any one of the above (1) to (3), in which a content of the glutinous brown rice is 10 to 49% by weight, a content of the gelling agent is 0.1 to 3% by weight, and a content of water is 50 to 70% by weight.
(5) A method of producing the retort-pouch shaped food according to any one of the above (1) to (4), the method including: a first step of preparing a viscous liquid containing the glutinous brown rice and the gelling agent; a second step of filling a pouch with the viscous liquid; and a third step of performing retort heat sterilization to the pouch and cooling the pouch, to solidify a content of the pouch into a single lump.

### Advantageous Effects of the Invention

The retort pouch-shaped food is a food product that is formed into a single lump to be taken out of a retort pouch and eaten immediately without heating, has a texture of rice grains like onigiri or ohagi, which break apart in a mouth, and has excellent preservation properties.

### BRIEF DESCRIPTION OF THE DRAWINGS

FIG. 1 is a schematic diagram of a retort-pouch shaped food obtained in Example 1.

### DESCRIPTION OF EMBODIMENTS

The retort-pouch shaped food according to the present invention will be described below in detail.

The retort-pouch shaped food according to the present invention represents a “product that is obtained by packing a prepared food in a container (limited only to a container having airtightness and light-shielding property) obtained by shaping a plastic film, metal foil, or a multilayer formed by stacking plastic films and metal foils into a bag-like shape or other shapes, sealing the resultant product by heat melting, and performing sterilization by pressurization and heating”, as defined as a retort pouch food by “Quality Labeling Standard for Retort Pouch Food (notified by Consumer Affairs Agency in Japan)”.

In the present invention, a pouch refers to the container, and a retort pouch refers to a pouch that can be sterilized by pressurization and heating.

The retort-pouch shaped food according to the present invention refers to a shaped product produced by filling the container with a prepared food, sealing the container by heat melting, and then performing sterilization by pressurizing and heating (also called retort heat sterilization).

In the retort-pouch shaped food according to the present invention, contents of the pouch are in the form of a single lump. More specifically, the retort-pouch shaped food is a single lump of glutinous brown rice in which brown rice grains are bound together while maintaining the shape of each brown rice grain. The strength of the lump should be such that the glutinous brown rice grains are bound to each other to the extent that the lump does not deform greatly, collapse, or fall apart even when the retort-pouch shaped food is pressed from the outside of the pouch with a finger. Thus, for example, low-strength products such as cooked rice grains that can be easily separated from each other when lightly pushed out with chopsticks or the like are excluded.

The retort-pouch shaped food according to the present invention contains (a) glutinous brown rice and (b) a gelling agent.

### (a) Glutinous Brown Rice

Japanese rice is broadly classified into two species: uruchi (non-glutinous) species and glutinous species. Glutinous brown rice is brown rice of the glutinous species.

In glutinous rice, almost 100% of starch is amylopectin, in contrast to non-glutinous rice that contains about 80% amylopectin and about 20% amylose in starch. The glutinous rice includes, for example, short-grain japonica rice, medium-grain javanica rice, and long-grain indica rice, but the glutinous rice used in the present invention is not particularly limited. Among the examples, glutinous japonica rice is preferably used, in view of easy producibility of a texture similar to those of foods such as onigiri and ohagi that are popular in Japan.

The brown rice is characterized by removing a rice hull from a rice grain, and is composed of a central portion including tan endosperm and a germ, and a bran layer covering the central portion. As the brown rice, so-called “partly milled rice” such as 30%-milled grain rice, 50%-milled grain rice, and 70%-milled grain rice, in which a part of the bran is removed, can also be used. In addition, so-called “germinated brown rice”, in which the brown rice is germinated, can be used as the brown rice.

The present invention is unique in using glutinous brown rice.

If brown rice of non-glutinous species is used, the starch ages immediately after the production through the retort heat sterilization, resulting in an undesirable texture. If white rice or germ rice from which the bran layer is removed is used instead of the brown rice, spillage of the starch results in an undesirable texture. Therefore, a content of rice other than the glutinous brown rice in the retort-pouch shaped food according to the present invention is preferably less than 10% by weight, more preferably less than 5% by weight, and may be 0% by weight.

In the retort-pouch shaped food according to the present invention, a content of the glutinous brown rice is preferably 10 to 49% by weight, from the viewpoint of physical properties of the resulting retort-pouch shaped food that is in a single lump form and the viewpoint of the desired texture, and is more preferably 25 to 45% by weight, especially from the viewpoint of the retort-pouch shaped food with an onigiri-like texture.

### (b) Gelling Agent

The gelling agent is used for preventing precipitation of the glutinous brown rice dispersed in a viscous liquid produced during a manufacturing process in the manufacturing method of the present invention, for obtaining the desired texture in the finally obtained retort-pouch shaped food, and for binding glutinous brown rice grains. If no gelling agent is used, the prevention of precipitation during the manufacturing processes and the binding in the final product will be insufficient.

The gelling agent used in the present invention is not limited to the gelling agent as a food additive, and may be any agent that causes an aqueous solution to gelate by heating. Examples of such an agent include polysaccharides such as glucomannan (konjac powder), agar, psyllium, pectin, gellan gum, carrageenan, xanthan gum, and locust bean gum, gelatin, and modified starch. Among them, glucomannan, agar, and psyllium are preferable in consideration of production suitability.

One kind of the gelling agent may be used alone, or two or more kinds of the gelling agents may be mixed and used.

In the retort-pouch shaped food according to the present invention, a content of the gelling agent is not particularly limited as long as an appropriate thickening effect for preventing the precipitation of glutinous brown rice is exhibited, a content of the finally obtained retort-pouch shaped food is solidified into a single lump, and the food texture is not impaired. The content of the gelling agent is, for example, preferably 0.1 to 3% by weight and more preferably 0.3 to 2% by weight especially from the viewpoint of a retort pouch-shaped food with the onigiri-like texture.

### (c) any Other Component

The retort-pouch shaped food according to the present invention may contain, in addition to the components described in (a) and (b) above, any component including other grains (wheat, corn, millet), beans, nuts and seeds, tubers and roots, meats, seafoods, fruits, vegetables, dairy products, extracts derived from plants or animals, carbohydrates, dietary fiber, oil and fat, common salt, spices, herbs, condiments, acidulants, flavoring agents, coloring agents, and sweeteners. The state of each component is not particularly limited as long as it does not adversely affect the effects of the retort-pouch shaped food. For example, a dried product or a powdered product may be used. These optional components are appropriately selected and their physical properties and flavor are adjusted, thereby imparting a wide range of palatability to the retort-pouch shaped food.

The optional components can be used within a range in which the palatability and physicochemical stability of the retort-pouch shaped food are not adversely affected. The content of the optional components is not particularly limited, but should be 39% by weight or less, and may be 5% by weight or less.

### (d) Water

In the retort-pouch shaped food according to the present invention, a content of water is adjusted to obtain the desired food texture. In the retort-pouch shaped food according to the present invention, when the content of water is, for example, 50 to 70% by weight relative to the total content, moderately soft and chewy food texture is exhibited.

The content of water refers to a total water content including not only water to be added but also water derived from any other components.

As the means for determining the content of water, a calculation method for calculating the content of water from the water content of each ingredient, a reduced-pressure drying method, a Karl Fischer method, an infrared absorption method, or the like can be used.

The retort-pouch shaped food according to the present invention is sealed in a pouch, and subjected to a retort heat sterilization so as to be a single lump product mainly composed of glutinous brown rice.

The shaped product is merely required to have a single-lump shape as a whole in which the glutinous brown rice and other optional components are bound together. A shape of the product is not particularly limited, and may be a plate-like shape, a bar-like shape, a substantially spherical shape, a substantially ellipsoidal sphere shape, a substantially cylindrical shape, a substantially triangular pyramidal shape, a substantially prismatic shape, or the like, according to an internal shape of the pouch.

The retort-pouch shaped food according to the present invention is produced by mixing and dispersing glutinous brown rice and a gelling agent in water, filling a pouch with the resulting viscous liquid, and performing the retort heat sterilization to the pouch.

A pouch used in the present invention should be a container obtained by shaping a plastic film, metal foil, or a multilayer formed by stacking plastic films and metal foils into a bag shape or other shapes, and examples of the pouch include a flat bag and a standing pouch.

For the retort heat sterilization, a pressurizing and heating method known in the production of retort foods may be used. For example, a sealed pouch that is filled with the viscous liquid is put into a pressurizing and heating oven, and heated with steam or pressurized hot water at a temperature of 100° C. or higher. The heating is performed at a temperature of 110 to 130° C. for 10 to 60 minutes, for example. Thereafter, the resultant product is cooled at a normal temperature, so that the content of the pouch, i.e., the glutinous brown rice grains are bound and solidified into a single lump.

The retort-pouch shaped food obtained as described above can be taken out of the retort pouch in a state of a single lump in which the content of the pouch is bound and solidified to be eaten as it is at a normal temperature, and thus exhibits excellent portability and convenience with a high nutritive value. The retort-pouch shaped food has a moderately soft and chewy food texture similar to foods including rice processed into a lump, such as onigiri or ohagi.

Here, “be eaten as it is” means that the retort-pouch shaped food according to the present invention, which is taken out of the pouch, is safely eatable without cooking such as heating, and without using tableware.

The retort-pouch shaped food according to the present invention undergoes the heat sterilization and is sealed in a pouch. Thus, the quality of the retort-pouch shaped food is well maintained even when it is stored for a long period of time at a normal temperature. Therefore, the retort-pouch shaped food according to the present invention has excellent preservation properties.

The normal temperature means a temperature not exceeding an ambient temperature, and may be, for example, in a range of 15 to 30° C.

### EXAMPLES

The present invention will be described below in more detail with reference to Examples. It should be noted that the present invention is not limited to Examples in any way.

### Example 1

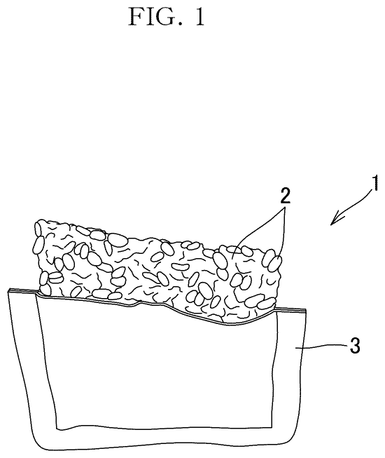

Water was put into a tank (10 L) equipped with a stirring blade, and a gelling agent, vegetable oil and fat, common salt, and condiments (sodium glutamate) were added and mixed in the water to prepare a mixed liquid. Subsequently, glutinous brown rice was put into the mixed liquid and mixed at a room temperature to produce a viscous liquid. 55 g of the viscous liquid was poured in a flat-bag shaped pouch having a size of 80 mm×140 mm, and the pouch was sealed. The resultant pouch was thereafter subjected to retort heat sterilization at 120° C. for 40 minutes, thereby obtaining a retort-pouch shaped food. As shown in FIG. 1, the obtained retort-pouch shaped food 1 taken out of a pouch 3 was a single lump having a plate shape in which glutinous brown rice 2 was bound together, and was eatable as it was at a normal temperature. Blending ratios of the ingredients in the final retort-pouch shaped food are as shown in Table 1. The content of each of the components listed in Table 1, except water, indicates solid weight.

### Examples 2 to 5, Comparative Examples 1 to 3

Retort-pouch shaped foods were each obtained in the same manner as in Example 1 while kinds and contents of the ingredients were changed as shown in Table 1.

TABLE 1

| | | | | | | | Comp. | Comp. | Comp. |
|---|---|---|---|---|---|---|---|---|---|
| | | Ex. 1 | Ex. 2 | Ex. 3 | Ex. 4 | Ex. 5 | Ex. 1 | Ex. 2 | Ex. 3 |
| Blending | Glutinous brown rice | 41 | 42 | 45 | 30 | 11 | 41 | | |
| ratio | Non-glutinous brown rice | | | | | | | 41 | |
| (% by | Glutinous rice (white rice) | | | | | | | | 41 |
| weight) | Konjac powder *1 | | 0.3 | 1 | 2 | | | 1 | 1 |
| | Psyllium *2 | 1 | | | | 0.5 | | | |
| | Agar *3 | | | | | 1.7 | | | |
| | Common salt | 0.8 | 0.8 | 0.8 | | | 0.8 | 0.8 | 0.8 |
| | Sodium glutamate | 0.2 | 0.2 | 0.2 | | | 0.2 | 0.2 | 0.2 |
| | Vegetable oil and fat | 2 | 1.7 | | 1 | 1.8 | 2 | 2 | 2 |
| | Dried azuki bean flour | | | | | 10 | | | |
| | Sugar | | | | | 24 | | | |
| | Water | 55 | 55 | 53 | 67 | 51 | 56 | 55 | 55 |
| Content | Glutinous brown rice (weight %) | 41 | 42 | 45 | 30 | 11 | 41 | 0 | 0 |
| | Gelling agent (weight %) | 1 | 0.3 | 1 | 2 | 2.2 | 0 | 1 | 1 |
| | Water (weight %) | 55 | 55 | 53 | 67 | 51 | 56 | 55 | 55 |

*1 Product name: ULTRAMANNAN manufactured by Ina Food Industry Co., Ltd.
*2 Product name: Food Made P-100 manufactured by SHIKIBO LTD.
*3 Product name: Inakanten manufactured by Ina Food Industry Co., Ltd.

### [Test Example] Sensory Evaluation Test

The retort-pouch shaped foods obtained in Examples 1 to 5 and Comparative Examples 1 to 3 were subjected to sensory evaluation two weeks after the production to ensure stability of texture. The sensory evaluation was carried out by three expert panelists, and the results were summarized as shown in Table 1.

As in Table 1, the retort-pouch shaped foods obtained in Examples 1 to 4 were all in the form of a single lump of glutinous brown rice in which rice grains maintained the shape of brown rice grains and were bound together, and could be neatly taken out of the pouch as a single lump. For the texture, preferable grainy texture of the glutinous brown rice could be felt, which was similar to that of onigiri, i.e., each rice grain was distinctly felt, and preferable crumbled texture was also felt when the food was put into the mouth. The retort-pouch shaped food obtained in Example 5 was in the form of a single lump of glutinous brown rice in which the glutinous brown rice grains maintained their grainy shape and were bound together, and could be neatly taken out of the pouch as a single lump. Although the amount of glutinous brown rice was small and the retort-pouch shaped food did not have the texture of distinct rice grains like onigiri, it had a chewy texture of glutinous brown rice grains similar to ohagi.

On the other hand, when no gelling agent was used as in Comparative Example 1, it was difficult to uniformly disperse the glutinous brown rice in the viscous liquid during production, and precipitation occurred, resulting in poor production suitability. A final product after the retort heat sterilization did not form a single lump. When non-glutinous brown rice was used as a main ingredient as in Comparative Example 2, starch retrograded and the product became crumbly. When white rice of the glutinous rice was used as the main ingredient as in Comparative Example 3, it was difficult to take the product out of the pouch, and the texture of rice grains was lost, resulting in an undesirable texture.

In addition, all of the retort-pouch shaped foods obtained in Examples 1 to 4 were subjected to the retort heat sterilization, and thus had excellent preservability. Qualities of the retort-pouch shaped foods were well maintained without deterioration, even when the foods were stored for a long period of time at a normal temperature.

### DESCRIPTION OF THE REFERENCE CHARACTERS

1 Retort-pouch shaped food
2 Glutinous brown rice
3 Retort pouch

1. A retort-pouch shaped food, comprising:
glutinous brown rice; and
a gelling agent, wherein
a content of the glutinous brown rice is 10 to 49% by weight,
a content of the gelling agent is 0.1 to 3% by weight,
a content of water is 50 to 70% by weight,
a content of rice except the glutinous brown rice is 10% by weight or less,
the gelling agent is one or more ingredients selected from glucomannan, agar, and psyllium, and
a content of a pouch is bound into a single lump, and has a shape that fits an internal shape of the pouch.

2. The retort-pouch shaped food according to claim 1,
which is eatable as it is at a normal temperature.

3. (canceled)

4. (canceled)

5. A method of producing the retort-pouch shaped food according to claim 1, the method comprising:
a first step of preparing a viscous liquid containing the glutinous brown rice and the gelling agent;
a second step of filling a pouch with the viscous liquid; and
a third step of performing retort heat sterilization to the pouch and cooling the pouch, to solidify a content of the pouch into a single lump.

6. The retort-pouch shaped food according to claim 1, comprising 5% by weight or less of oil and fat.
